(19) United States
(12) Patent Application Publication
(10) Pub. No.: US 2026/0355929 A1
(43) Pub. Date: Nov. 12, 2026

(54) DRAWER SLIDE PANEL OF AUTOMOTIVE TOOL CABINET

(71) Applicant: SUN CHAIN TRADING CO., LTD., TAIPEI CITY (TW)

(72) Inventor: HSIN-TZU YAO, TAIPEI CITY (TW)

(21) Appl. No.: 19/204,626

(22) Filed: May 12, 2025

(51) Int. Cl. B25H 3/02; A47B 88/473

(52) U.S. Cl. CPC B25H 3/028; A47B 88/473

(57) ABSTRACT

A drawer slide panel of an automotive tool cabinet, including a front panel, a handgrip, two shafts, two cover plates, two links, and two elastic elements, is installed on the front of a drawer. The drawer is connected to the automotive tool cabinet by two drawer slides serving as a locking and opening means. Each drawer slide includes an opening mechanism with a trigger plate. The handgrip is provided on the front of the front panel. Two pushing parts are formed inside the handgrip for pushing the trigger plate. By the linkage between the handgrip, shafts, links, and elastic elements, when the handgrip is pulled outward or pushed inward, any one of the pushing parts presses the trigger plate to release the locked state of the drawer slide, and the front panel can be pushed in the opposite direction to retract and return the drawer slide to the locked state.

### BACKGROUND OF THE DISCLOSURE

### Technical Field

The present disclosure relates to the technical field of slide rail accessories, and particularly relates to a drawer slide panel of an automotive tool cabinet, wherein the drawer slide panel is installed on the front of a drawer, the drawer is connected to the automotive tool cabinet by a pair of drawer slides as a means of locking drawer and assisting the sliding of the drawer, the panel is provided with a handgrip, the panel can be operated to release the locked state of the drawer slide by pulling the handgrip outward or pushing the handgrip inward, or operated reversely to push the drawer to return to the locked state, thereby significantly improving the convenience of operation.

### Description of the Related Art

Most of the existing drawer handles are integrally formed or otherwise combined with the front of a drawer to provide a convenient way of opening or closing the drawer. However, automotive tool cabinet drawers, mobile shelves, etc. need to carry heavier objects and may need to be moved, resulting in the possibility that the drawer may slide out during movement. Therefore, a fixable slide device is required to avoid the locked state of the drawer when not in use.

At present, automotive tool cabinets are often used in automobile repair shops, assembly workshops or other mechanical manufacturing technologies and applications to store large-scale tool sets, such as socket wrench sets, screwdrivers, box wrenches, opening wrenches, files, pliers and various other hand tools, which may have a total weight up to several hundred kilograms. Therefore, the tool cabinet usually needs to have a mobile function for the convenience of use, and the fixable slide rail device is designed exactly for such a function, so the automotive tool cabinet can be quickly and easily placed at the required work location, and can prevent the drawer from opening arbitrarily due to movement or tilting, the scattering of objects inside the automotive tool cabinet, or the tipping over of the automotive tool cabinet caused by the shift in center of gravity after the drawer is opened. For this purpose, the drawer must be equipped with a corresponding control means of the fixable slide rail device. In general, the control means is operated by pressing a button or pulling a handgrip, and both hands of the user must be used at the same time. However, it will be difficult for users to operate the control means when holding tools or other objects in the hands. Obviously, improvements are required.

In view of the aforementioned problems, the discloser of the present disclosure has conducted extensive research and experiment, and finally developed a drawer slide panel of an automotive tool cabinet, which is installed on the front of a drawer. The drawer is connected to the automotive tool cabinet by a pair of drawer slides to lock the drawer and assist sliding. The drawer slide panel includes a front panel, a handgrip, a pair of shafts, a pair of cover plates, a pair of links and a pair of elastic elements. When the handgrip is pulled outward or pushed inward, any one of the pushing parts presses and squeezes the trigger plate to release the locked state of the drawer slide. If the front panel is pushed in the opposite direction, the drawer slide will retract and return to the locked state. In this way, the drawer slide can be operated with one hand, thus improving the inconvenience of the related-art fixable slide device that requires two hands to operate.

### SUMMARY OF THE DISCLOSURE

The primary objective of the present disclosure is to provide a drawer slide panel of an automotive tool cabinet, which can be operated with one hand, and the drawer slide panel includes a front panel, a handgrip, a pair of shafts, a pair of cover plates, a pair of links and a pair of elastic elements. The drawer slide panel is installed on the front of a drawer, and the drawer is connected to the automotive tool cabinet by the pair of drawer slides to serve as a means of locking the drawer slide and opening the drawer. With the linkage between the handgrip, the pair of shafts, the pair of links and the pair of elastic elements, the handgrip can be pulled outward or pushed inward by one hand to make any one of the pushing parts squeeze the trigger plate to release the locked state of the drawer slide. The front panel can be pushed in the opposite direction to retract and return the drawer slide to the locked state, thereby greatly improving the convenience of operation.

To achieve the aforementioned objective, the present disclosure discloses a drawer slide panel of an automotive tool cabinet, which is installed on the front of a drawer, the drawer is connected to the automotive tool cabinet by a pair of drawer slides as a locking and opening means, each drawer slide is provided with an opening mechanism, the opening mechanism includes a trigger plate capable of releasing a locked state of the drawer slide after the trigger plate is pressed. The drawer slide panel includes: a front panel, with an accommodation space defined therein, and the front panel being C-shaped when viewed from the side, and provided with an opening, and the inner side of the opening being provided with a pivot groove; a handgrip, provided with a pivot part and movably installed inside the pivot groove, and having one end, opposite the pivot part, extended and formed into a curved handgrip bar to align with the front panel, and the other end formed into two C-shaped pushing parts for pressing against the trigger plate; a pair of shafts, fixed to two ends of the handgrip respectively to limit the horizontal displacement of the handgrip in the pivot groove and form a linkage with the handgrip; a pair of cover plates, covering the two ends of the front panel to close the accommodation space, and a notch being provided on a side of each cover plate to extend the trigger plate into the cover plate so that the trigger plate is close to the pushing part, and a pivot column and a first hook being provided on the inner wall of each cover plate; a pair of links, each being provided with a pivot hole for movably pivoted to the pivot column, and a side of the pivot hole being provided with a driving part and a second hook, such that the driving part abuts the shaft correspondingly; and a pair of elastic elements, coupled to the first hook and the second hook respectively, for providing an elastic force required for the pair of links to return to their original positions, and linking the pair of shafts and the handgrip to return to their original positions; such that, by operating the handgrip to pull outward or push inward, any one of the pushing parts squeezes the trigger plate and releases the locked state of the drawer slide to pull out the drawer; conversely, by pushing the front panel in the opposite direction, the drawer can be immediately pushed in, and by using the restoring elastic force of the elastic element to release the pressure on the pair of links, so as to return the trigger plate to its original position and resumes the locked state.

In an embodiment of the present disclosure, the handgrip is provided with a fixing hole corresponding to two ends of pivot part respectively, and each shaft is provided with a fixing pin corresponding to one of the fixing holes, for passing the fixing pin through the fixing hole and integrally combined with the handgrip.

In another embodiment of the present disclosure, the shaft is provided with a pair of extension rods corresponding to the two pushing parts respectively to define a three-point clamping method after installation. Each link is L-shaped, the pivot hole is located at the center, and the driving part and a second hook are arranged respectively on two sides of the pivot hole, which are two ends of the link. In this embodiment, the C-shaped pushing part arranged on top is a first pushing part, the C-shaped pushing part arranged on bottom is a second pushing part, and the two C-shaped pushing parts are provided for abutting the upper edge and lower edge of the trigger plate respectively. When the handgrip is pulled outward, the first pushing part applies pressure on the upper edge of the trigger plate to release a locked state of the drawer slide; and when the handgrip is pushed inward, the second pushing part applies pressure on the lower edge of the trigger plate to release the locked state of the drawer slide. In addition, the first pushing part and the second pushing part are both in a circular shape when viewed from the side, which ensures that the abutment force exerted on the trigger plate is maintained. In addition, a surface of the handgrip is provided with an anti-slip pattern, and the anti-slip pattern is a plurality of ribs spaced from each other and arranged in parallel to each other.

### BRIEF DESCRIPTION OF THE DRAWINGS

FIG. 1 is an exploded view of a preferred embodiment of the present disclosure;

FIG. 2 is a schematic perspective view showing the assembly of a preferred embodiment of the present disclosure;

FIG. 3 is a first schematic view showing the operation status of a preferred embodiment of the present disclosure;

FIG. 4 is a second schematic view showing the operation status of a preferred embodiment of the present disclosure; and

FIG. 5 is a third schematic view showing the operation status of a preferred embodiment of the present disclosure.

### DESCRIPTION OF THE PREFERRED EMBODIMENTS

The following description together with the attached drawings are provided to enable our examiner to clearly understand the technical contents of the present disclosure.

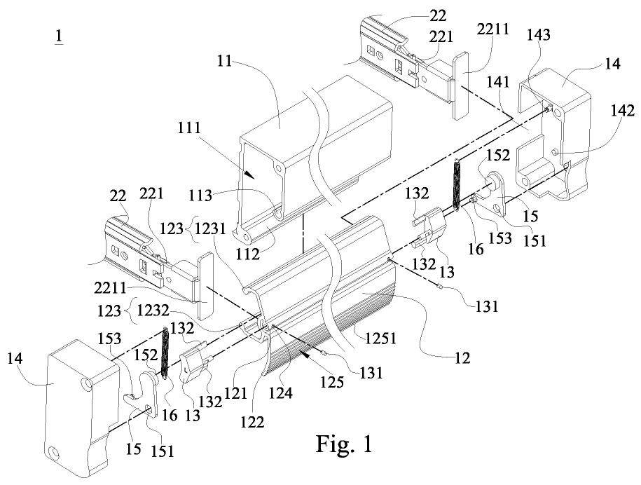

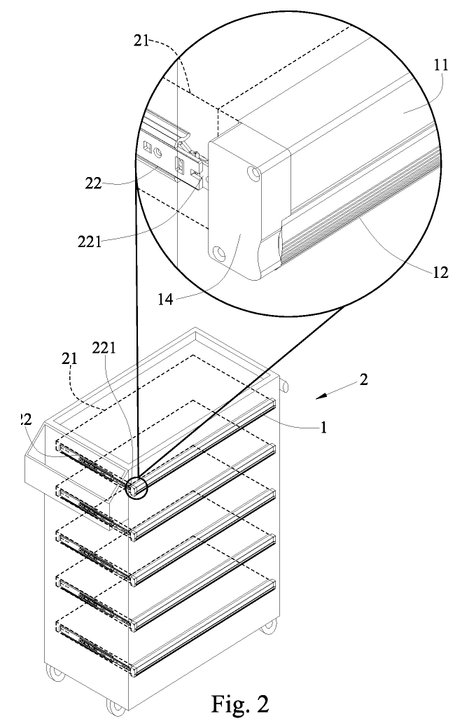

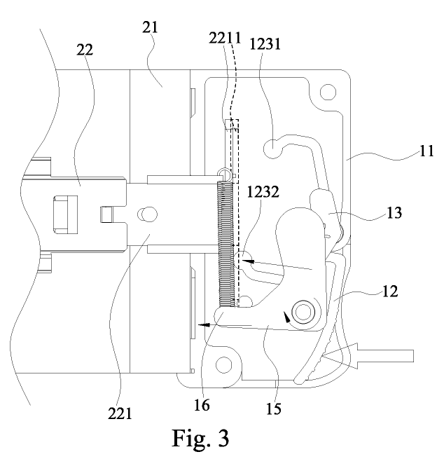

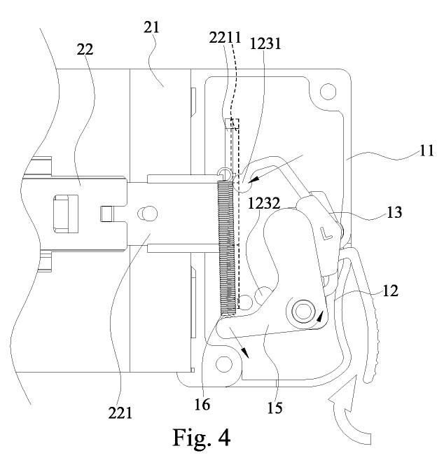

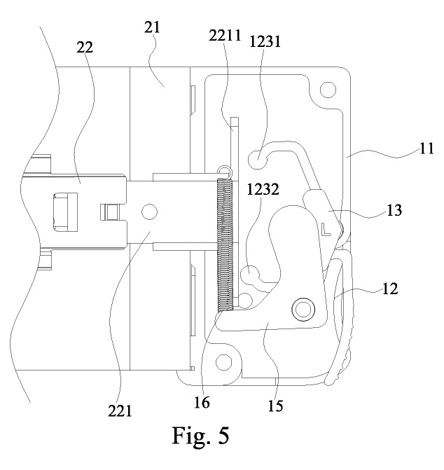

With reference to FIGS. 1, 2 and 3-5 for the exploded view and the perspective assembly view of a drawer slide panel 1 of an automotive tool cabinet 2 in accordance with a preferred embodiment of the present disclosure and the schematic views of different operating statuses of the present disclosure respectively, the drawer slide panel 1 is installed on the front of a drawer 21, the drawer 21 is connected to the automotive tool cabinet 2 by a pair of drawer slides 22 as a locking and opening means, each drawer slide 22 is provided with an opening mechanism 221, the opening mechanism 221 includes a trigger plate 2211 capable of releasing a locked state of the drawer slide 22 after the trigger plate 2211 is pressed. The drawer slide panel 1 includes a front panel 11, a handgrip 12, a pair of shafts 13, a pair of cover plates 14, a pair of links 15 and a pair of elastic elements 16.

Wherein, an accommodation space 111 is defined in the front panel 11, the front panel 11 is C-shaped when viewed from the side, and provided with an opening, and the inner side of the opening 112 is provided with a pivot groove 113.

The handgrip 12 includes a pivot part 121 movably installed in the pivot groove 113, an end of the handgrip 12, opposite the pivot part 121, is extended and formed with a curved handgrip bar 122 to align with the front panel 11, and another end of the handgrip 12 is formed into two C-shaped pushing parts 123 for pressing against the trigger plate 2211.

Each shaft 13 is fixed to two ends of the handgrip 12 respectively to limit the horizontal displacement of the handgrip in the pivot groove and form a linkage with the handgrip.

Each cover plate 14 covers two ends of the front panel 11 to close the accommodation space, and a side of each cover plate 14 is provided with a notch 141 for extending the trigger plate 2211 into the cover plate 14, so that the trigger plate 2211 is close to the pushing part 123. In addition, the inner wall of each cover plate 14 is provided with a pivot column 142 and a first hook 143.

Each link 15 has a pivot hole 151 movably pivoted to the pivot column 142, and a side of the pivot hole 151 is provided with a driving part 152 and a second hook 153, such that the driving part 152 abuts against the shaft 13 correspondingly.

Each elastic element 16 is connected to the first hook 143 and the second hook 153 to provide an elastic force required for returning the pair of links 15 to its original position, and linking the pair of shafts 13 and the handgrip 12 to resume their original positions.

In addition, two ends of the handgrip 12 corresponding to the pivot part 121 are provided with a fixing hole 124 respectively, and each shaft 13 is provided with a fixing pin 131 corresponding to the fixing hole 124 for passing the fixing pin 131 through the fixing hole 124 and integrally combining with the handgrip 12. Each shaft 13 is provided with a pair of extension rods 132 corresponding to the two pushing parts 123 respectively to form a three-point clamping method after installation. In addition, each link 15 is L-shaped, the pivot hole 151 is located at the center, and the driving part 152 and a second hook 153 are arranged on two sides of the pivot hole 151, which are also the two ends of the link 15. In the present disclosure, the C-shaped pushing part 123 arranged on top is defined as a first pushing part 1231 and the C-shaped pushing part 123 arranged on bottom is defined as a second pushing part 1232 for abutting the upper edge and lower edge of the trigger plate 2211 respectively. When the handgrip 12 is pulled outward, the first pushing part 1231 applies pressure to the upper edge of the trigger plate 2211 to release the locked state of the drawer slide 22; and when the handgrip 12 is pushed inward, the second pushing part 1232 applies pressure to the lower edge of the trigger plate 2211 to release the locked state of the drawer slide 22. Furthermore, one of the first pushing part 1231 and the second pushing part 1232 is in a circular shape when viewed from the side to ensure that the pressure exerted on the trigger plate 2211 can be maintained. In order to provide a better grip during operation, the surface of the handgrip 12 of the present disclosure is provided with an anti-slip pattern 125, and the anti-slip pattern 124 is a plurality of ribs 1251 arranged in intervals and parallel to each other.

In this way, the drawer slide panel 1 of the present disclosure can be pulled outward or pushed inward by operating the handgrip 12 with one hand, and through the linkage relationship between the handle 12, the pair of rotating shafts 13, the pair of connecting rods 15 and the pair of elastic elements 16, any one of the push portions 123 is driven to squeeze the trigger plate 2211, thereby releasing the locked state of the drawer slide 22 to pull the drawer outward. Furthermore, when the front panel 11 is pushed in the opposite direction, the drawer 21 can be pushed in immediately, and the elastic force of the elastic element 16 can be used to release the pressure on the pair of links 15, so that the handgrip 12 returns to its original position, and the trigger plate also returns to its original position and resumes the locked state, thereby achieving the purpose of improving the convenience of operation, and its intuitive operation method does not require additional learning for the operation and use.

What is claimed is:

1. A drawer slide panel of an automotive tool cabinet installed on a front of a drawer, the drawer being coupled to the automotive tool cabinet by a pair of drawer slides as a locking and opening means, each drawer slide being provided with an opening mechanism, the opening mechanism comprising a trigger plate capable of releasing a locked state of the drawer slide after the trigger plate is pressed, and the drawer slide panel comprising:
a front panel with an accommodation space defined therein, and the front panel being C-shaped when viewed from a side, and provided with an opening, and an inner side of the opening being provided with a pivot groove;
a handgrip provided with a pivot part and movably installed inside the pivot groove, and having one end, opposite the pivot part, extended and formed into a curved handgrip bar to align with the front panel, and another end formed into two C-shaped pushing parts for pressing against the trigger plate;
a pair of shafts fixed to two ends of the handgrip, respectively, to limit a horizontal displacement of the handgrip in the pivot groove and to form a linkage with the handgrip;
a pair of cover plates covering two ends of the front panel to close the accommodation space, and a notch being provided on a side of each cover plate to extend the trigger plate into the cover plate so that the trigger plate is close to the two C-shaped pushing parts, and a pivot column and a first hook being provided on an inner wall of each cover plate;
a pair of links, each being provided with a pivot hole for movably pivoted to the pivot column, and a side of the pivot hole being provided with a driving part and a second hook, such that the driving part abuts a corresponding shaft; and
a pair of elastic elements, each coupled to the first hook and the second hook, for providing an elastic force required for the pair of links to return to their original positions, and linking the pair of shafts and the handgrip to return to their original positions,
wherein, by operating the handgrip to pull outward or push inward, any one of the two C-shaped pushing parts squeezes the trigger plate and releases the locked state of the drawer slide to pull out the drawer, and conversely, by pushing the front panel in an opposite direction, the drawer is capable of being immediately pushed in the drawer to return the trigger plate to its original position and resume the locked state by using the elastic force of the elastic element to release pressure on the pair of links.

2. The drawer slide panel of an automotive tool cabinet according to claim 1, wherein the handgrip is provided with a fixing hole corresponding to two ends of the pivot part, respectively, and each shaft is provided with a fixing pin with respect to a corresponding fixing hole for passing the fixing pin through the corresponding fixing hole to integrally combine with the handgrip.

3. The drawer slide panel of an automotive tool cabinet according to claim 1, wherein the pair of shafts is provided with a pair of extension rods corresponding to the two C-shaped pushing parts, respectively, to define a three-point clamping method after installation.

4. The drawer slide panel of an automotive tool cabinet according to claim 1, wherein each link is L-shaped, the pivot hole is located at a center of the link, the driving part and the second hook are arranged, respectively, on two sides of the pivot hole, which are two ends of the link.

5. The drawer slide panel of an automotive tool cabinet according to claim 1, wherein the two C-shaped pushing parts has a first pushing part arranged on top and a second pushing part arranged on bottom, and the first and second pushing parts are provided for abutting an upper edge and a lower edge of the trigger plate, respectively,
when the handgrip is pulled outward, the first pushing part applies pressure on the upper edge of the trigger plate to release the locked state of the drawer slide, and
when the handgrip is pushed inward, the second pushing part applies pressure on the lower edge of the trigger plate to release the locked state of the drawer slide.

6. The drawer slide panel of an automotive tool cabinet according to claim 5, wherein the first pushing part and the second pushing part are both in a circular shape when viewed from the side, which ensures that an abutment force exerted on the trigger plate is maintained.

7. The drawer slide panel of an automotive tool cabinet according to claim 1, wherein a surface of the handgrip is provided with an anti-slip pattern, and the anti-slip pattern includes a plurality of ribs spaced from each other and arranged in parallel to each other.
